(19) United States
(12) Patent Application Publication
(10) Pub. No.: US 2024/0345548 A1
(43) Pub. Date: Oct. 17, 2024

(54) LEARNING CLOSED-LOOP CONTROL POLICIES FOR MANUFACTURING

(71) Applicants: Massachusetts Institute of Technology, Cambridge, MA (US); The Trustees of Princeton University, Princeton, NJ (US); Institute of Science and Technology Austria, Klosterneuburg (AT); Universita Della Svizzera Italiana, Lugano (CH)

(72) Inventors: Michael J. Foshey, Quincy, MA (US); Wojciech Matusik, Lexington, MA (US); Bernd Bickel, Klosterneuburg (AT); Michal Piovarci, Tulln An Der Donau (AT); Szymon Rusinkiewicz, Princeton, NJ (US); Piotr Didyk, Pregassona (CH)

(21) Appl. No.: 18/626,653

(22) Filed: Apr. 4, 2024

Related U.S. Application Data
(63) Continuation of application No. PCT/US22/45662, filed on Oct. 4, 2022.
(60) Provisional application No. 63/252,418, filed on Oct. 5, 2021.

(51) Int. Cl. G05B 13/02

(52) U.S. Cl. CPC G05B 13/0265

(57) ABSTRACT

A manufacturing system and method involves learning a self-correcting closed-loop control policy through machine reinforcement learning for a manufacturing process that involves on-the-fly adjustment of process parameters to handle inconsistencies in the manufacturing process and material formulations, and controlling operation of a tool configured to interact with or produce a product including dynamically adjusting at least one parameter of the manufacturing process to thereby dynamically adjust operation of the tool based on qualitative performance information derived from at least one sensor applied as feedback to the closed-loop control policy learned through machine reinforcement learning.

### CROSS-REFERENCE TO RELATED APPLICATION(S)

This patent application is a continuation of PCT Application No. PCT/US2022/045662 entitled LEARNING CLOSED-LOOP CONTROL POLICIES FOR MANUFACTURING filed Oct. 4, 2022, which claims the benefit of U.S. Provisional Patent Application No. 63/252,418 entitled LEARNING CLOSED-LOOP CONTROL POLICIES FOR MANUFACTURING filed Oct. 5, 2021, each of which is hereby incorporated herein by reference in its entirety.

### STATEMENT REGARDING FEDERALLY SPONSORED RESEARCH

This invention was made with Government support under Grant Nos. IIS1815585 and IIS1815070 awarded by the National Science Foundation. The Government has certain rights in the invention.

### FIELD OF THE INVENTION

The invention generally relates to a self-correcting closed-loop control policy such as for additive or subtractive manufacturing through machine learning, e.g., with regard to deposition of viscous materials in situations that involve on-the-fly adjustment of process parameters to handle inconsistencies in the deposition process and material formulations.

### BACKGROUND OF THE INVENTION

Generally speaking, additive manufacturing is the process of creating an object by building it one layer at a time. Technically, additive manufacturing can refer to any process where a product is created by building something up but it is commonly used to refer to 3D printing.

### SUMMARY OF VARIOUS EMBODIMENTS

In accordance with one embodiment of the invention, a manufacturing system comprises a tool configured to interact with or produce a product, at least one sensor that provides sensor information on the quality of the operation of the tool relative to the product, and a controller configured to control operation of the tool based on a predetermined manufacturing process and further configured to dynamically adjust at least one parameter of the predetermined manufacturing process to thereby dynamically adjust operation of the tool based on qualitative performance information derived from the sensor information applied as feedback to a closed-loop control policy learned through machine reinforcement learning.

In various alternative embodiments, the tool may perform an additive manufacturing process and/or a subtractive manufacturing process. The at least one sensor may include one or more cameras (e.g., two cameras), a 3D laser scanner, and/or a coordinate measuring machine. The tool may be a CNC machine. The controller may utilize a policy network for controlling the manufacturing process, wherein the policy network is trained using a learning environment that models the relationship between the process parameters and result as well as a reward function that penalizes or rewards the policy depending on how well the policy performed. In any case, the controller may be manufacturing process agnostic such that the controller can be used on different types of manufacturing processes.

In certain specific embodiments, the tool may be a 3D printer having a material dispenser, the at least one sensor may include at least one camera (e.g., two cameras) configured to provide images of a location around the deposition, and the closed-loop control policy may use qualitative performance information derived from the images. The qualitative performance information may include both deposition and variance of deposition. The at least one parameter may include (1) the velocity at which the printing head is moving and/or (2) displacement of the printing head in a direction perpendicular to the motion.

In accordance with another embodiment of the invention, a method comprises learning a self-correcting closed-loop control policy through machine reinforcement learning for a manufacturing process that involves on-the-fly adjustment of process parameters to handle inconsistencies in the manufacturing process and material formulations, and controlling operation of a tool configured to interact with or produce a product including dynamically adjusting at least one parameter of the manufacturing process to thereby dynamically adjust operation of the tool based on qualitative performance information derived from at least one sensor applied as feedback to the closed-loop control policy learned through machine reinforcement learning.

In various alternative embodiments, the tool may perform an additive manufacturing process and/or a subtractive manufacturing process. The at least one sensor may include one or more cameras (e.g., two cameras), a 3D laser scanner, and/or a coordinate measuring machine. The tool may be a CNC machine. The controller may utilize a policy network for controlling the manufacturing process, wherein the policy network is trained using a learning environment that models the relationship between the process parameters and result as well as a reward function that penalizes or rewards the policy depending on how well the policy performed. In any case, the controller may be manufacturing process agnostic such that the controller can be used on different types of manufacturing processes.

In certain specific embodiments, the tool may be a 3D printer having a material dispenser, the at least one sensor may include at least one camera (e.g., two cameras) configured to provide images of a location around the deposition, and the closed-loop control policy may use qualitative performance information derived from the images. The qualitative performance information may include both deposition and variance of deposition. The at least one parameter may include (1) the velocity at which the printing head is moving and/or (2) displacement of the printing head in a direction perpendicular to the motion.

Additional embodiments may be disclosed and claimed.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 is a schematic diagram showing a reference slice.

FIG. 2 shows an observation space in accordance with one embodiment.

FIG. 3 shows an action space in accordance with one embodiment.

FIG. 4 shows a comparison of time-based discretization and distance-based discretization in accordance with one embodiment.

FIG. 5 shows an example of how orientation can be used in accordance with one embodiment.

FIG. 6 shows an example of formulating a predictive generative model in accordance with one embodiment.

FIG. 7 shows various models from an evaluation dataset.

FIG. 8 shows an evaluation of the performance of our control policy visualized as an improvement over the reference.

FIG. 9 shows exemplar printouts from an evaluation dataset.

FIG. 10 shows printouts realized using control policies recovered with Bayesian optimization compared to our trained policy.

FIG. 11 shows a comparison of state-of-the-art slicers with our policy in environments with varying viscosity.

FIG. 12 shows an infill comparison between a reference policy and our control policy.

FIG. 13 shows a 3D printing apparatus with cameras in accordance with one embodiment.

FIG. 14 demonstrates the calibration of the imaging setup in accordance with one embodiment.

FIG. 15 shows a printing bed model used in one embodiment.

FIG. 16 demonstrates thickness estimation in accordance with one embodiment.

FIG. 17 shows print boundary, thickness, and nozzle path for the thickness estimation shown in FIG. 16.

FIG. 18 shows a representation of a reward function in accordance with one embodiment.

FIG. 19 shows some models that were used for training in one embodiment.

FIG. 20 shows training curves for controllers with constant material flow in accordance with one embodiment.

FIG. 21 shows training curves for controllers with increasing viscosity in an environment with noisy flow in accordance with one embodiment.

It should be noted that the foregoing figures and the elements depicted therein are not necessarily drawn to consistent scale or to any scale. Unless the context otherwise suggests, like elements are indicated by like numerals.

### DESCRIPTION OF ILLUSTRATIVE EMBODIMENTS

Certain embodiments are described herein with reference to additive manufacturing processes such as 3D printing using camera-based feedback, although it should be noted that embodiments are not limited to additive manufacturing or to camera-based feedback but instead can be applied more generally to a wide variety of other manufacturing processes and feedback mechanisms (essentially any type of sensor that can provide qualitative feedback of a manufacturing process, e.g., 3D laser scanner, coordinate measuring machine, etc.).

### 1 INTRODUCTION

A critical component of additive manufacturing is identifying process parameters of the material and deposition system to deliver consistent, high-quality printouts. In commercial devices, this is typically achieved by expensive trial-and-error experimentation (Gao et al., 2015). To make such an optimization feasible, a critical assumption is made: there exists a set of parameters for which the deposition is consonant. However, this assumption does not hold in practice because the printing materials are unstable non-homogenous mixtures. Their properties vary from batch to batch and, over time, as they settle or cure. These inconsistencies lead to printing imperfections that hinder the industrial adoption of additive manufacturing (Wang et al., 2020). Therefore, to achieve consistent prints, closed-loop control is a must for additive manufacturing.

Recently, there has been promising progress in learning policies for interaction with amorphous materials (Li et al., 2019b; Zhang et al., 2020). Unfortunately, in the context of additive manufacturing, discovering effective control strategies is significantly more challenging. The deposition parameters have a non-linear coupling to the dynamic material properties. To assess the severity of deposition errors, the material needs to be observed over long time horizons. Available simulators either lack predictive power (Mozaffar et al., 2018) or are too complex for learning (Tang et al., 2018; Yan et al., 2018). And learning on hardware is intractable, often requiring tens of thousands of printed samples. All of these challenges are further exaggerated by the limited perception of printing hardware where only a small in-situ view is available to assess the deposition quality.

A numerical model is proposed for learning closed-loop control policies for additive manufacturing. To formulate this model, a key assumption is made. The in-situ view of a printing apparatus allows it to perceive the materials only qualitatively. Different materials can be treated the same as long as their local deposition is similar. This assumption is leveraged to design an efficient simulator based on Position-Based-Dynamics. Linear Predictive Coding is used here to explicitly include the parameter coupling as a noise distribution on the width of the deposited material. Furthermore, the numerical model provides privileged information about the deposition process. More specifically, it allows evaluation of the quality of deposition in unobserved regions and include material changes over long-horizons. As demonstrated, the proposed model can be used to learn closed-loop policies that outperform state-of-the-art controllers. Moreover, it is shown that the proposed control policies have minimal sim-to-real gap and are readily applicable to the physical hardware. Finally, the proposed model was used to construct what is believed to be a first-of-its-kind closed-loop printing apparatus and use it to fabricate several slices. It is believed that the numerical model enables future research on optimal deposition control entirely in simulation without investing in specialized hardware.

### 2 RELATED WORK

To identify process parameters for additive manufacturing, it is important to understand the complex interaction between a material and a deposition process. This is typically done through trial-and-error experimentation (Kappes et al., 2018; Wang et al., 2018; Baturynska et al., 2018). Recently, optimal experiment design and more specifically Gaussian processes have become a tool for efficient use of the samples to understand the deposition problem (Erps et al., 2021). However, even though Gaussian Processes model the deposition variance, they do not offer tools to adjust the deposition on-the-fly. Another approach to improve the printing process is to design closed-loop controllers. One of the first designs was proposed by Sitthi-Amorn et al. (2015) that monitors each layer deposited by a printing process to compute an adjustment layer. Liu et al. (2017) build upon the idea and train a discriminator that can identify the type and magnitude of observed defects. A similar approach was proposed by Yao et al. (2018) that uses handcrafted features to identify when a print significantly drops in quality. The main disadvantage of these methods is that they rely on collecting the in-situ observations to propose one corrective step by adjusting the process parameters. However, this means that the prints continue with sub-optimal parameters and it can take several layers to adjust the deposition. In contrast, our system runs in-process and reacts to the in-situ views immediately. This ensures high-quality deposition and adaptability to material changes.

Recently, machine learning techniques have sparked a new interest in design of adaptive control policies (Mnih et al., 2015). A particularly successful approach for high quality in-process control is to adopt the Model Predictive Control paradigm (MPC) (Gu et al., 2016; Silver et al., 2017; Oh et al., 2017; Srinivas et al., 2018; Nagabandi et al., 2018). The control scheme of MPC relies on an observation of the current state and a short-horizon prediction of the future states. By manipulating the process parameters, we observe the changes in future predictions and can pick a future with desirable characteristics. Particularly useful is to utilize deep models to generate differentiable predictors that can be efficiently used to observe the derivatives with respect to control changes (de Avila Belbute-Peres et al., 2018; Schenck & Fox, 2018; Toussaint et al., 2018; Li et al., 2019a). However, addressing uncertainties of the deposition process with MPC is challenging. In a noisy environment, we can rely only on the expected prediction of the deposition. This leads to a conservative control policy that effectively executes the mean action. Moreover, reacting to material changes over time requires optimizing actions for long time horizons, which is a known weakness of the MPC paradigm (Garcia et al., 1989). As a result, MPC is not suitable for in-process control of noisy environments.

Another option to derive control policies is to leverage deep reinforced learning (Rajeswaran et al., 2017; Liu & Hodgins, 2018; Peng et al., 2018; Yu et al., 2019; Lee et al., 2019; Akkaya et al., 2019). The key challenge in design of such controllers is formulating an efficient numerical model that captures the governing physical phenomena. As a consequence, it is most commonly applied to rigid body dynamics and rigid robots, where such models are readily available (Todorov et al., 2012; Bender et al., 2014; Coumans & Bai, 2016; Lee et al., 2018). In contrast, learning with non-rigid objects is significantly more challenging, as the computation time for deformable materials is higher and relies on some prior knowledge of the task (Clegg et al., 2018; Elliott & Cakmak, 2018; Ma et al., 2018; Wu et al., 2019). Recently, Zhang et al. (2020) proposed a numerical model for training control policies in which a rigid object interacts with amorphous materials. Similarly, in the proposed model, a rigid printing nozzle interacts with the fluid-like printing material. However, the proposed model is specialized for the printing hardware and models not only the deposition but also its variance. It is demonstrated that this is an important component to minimize the sim-to-real gap and design control policies readily applicable to the physical hardware.

### 3 HARDWARE PRELIMINARIES

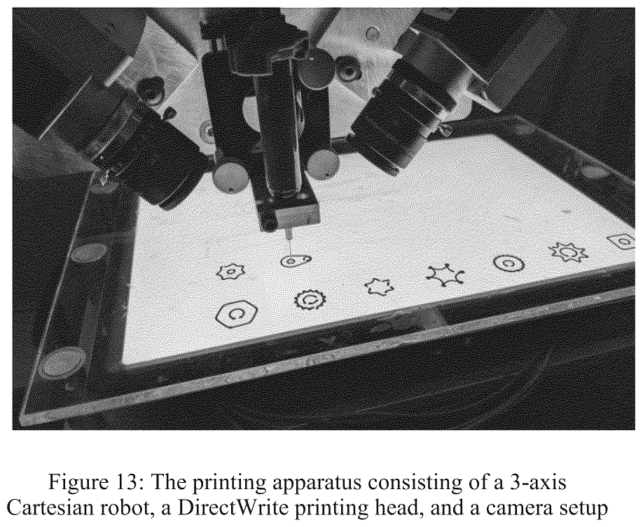

The choice of additive manufacturing technology constrains the subsequent numerical modeling. To keep the applicability of our developed system as wide as possible, the proposed model opted for a Direct-Write needle deposition system mounted on a 3-axis Cartesian robot as shown in FIG. 13. The dispenser can process a wide range of viscous materials, and the deposition is very similar to Fused Deposition Modeling. As shown in FIG. 13, we further enhanced the apparatus with two camera modules. The cameras lie on opposite sides of the nozzle to allow our apparatus to perceive the location around the deposition. It is this locality of the in-situ view that we will leverage to formulate our numerical model. For more details about the hardware and its calibration, please see Appendix A, which is incorporated herein physically and by reference.

### 3.1 State-of-the-Art Control Policy

To control the printing apparatus, a state-of-the-art slicer was employed. The input to the slicer is a three-dimensional object. The output of the slicer is a series of locations the printing head visits to reproduce the model as closely as possible. To generate a single slice of the object, the slicer starts by intersecting the 3D model with a Z-axis aligned plane (please note that this does not affect the generalizability of the slicer, as the input model can be arbitrarily rotated prior to slicing). FIG. 1 is a schematic diagram showing a reference slice. Here, the slice is represented by a polygon that marks the outline of the printout, FIG. 1 gray. To generate the printing path, a constant width of deposition (FIG. 1 red) that acts as a convolution on the printing path was assumed. The printing path (FIG. 1 blue) is created by offsetting the print boundary by half the width of the material using the Clipper algorithm (Johnson, 2015). The infill pattern is generated by tracing a zig-zag line through the area of the print (FIG. 1 green). For more details about calibration of the state-of-the-art control policy, please see Appendix B, which is incorporated herein physically and by reference.

### 4 REINFORCEMENT LEARNING FOR ADDITIVE MANUFACTURING

The reference control policy strictly relies on a constant width of the material. To discover policies that can adapt to the in-situ observations, the search was formulated in a reinforcement learning framework. The control problem is described by a Markov decision process ( [symbol] ), where [symbol] is a set of states, [symbol] ∈ [symbol] ^{d} is a d-dimensional continuous action that the control policy can take in each state, [symbol] =P(s′|s,a) is the transition function that is a distribution of next states s′ given a current state s and action a, and [symbol] (s,a)→ [symbol] is the reward function that assigns a numerical value to how good it is to be in state s and perform action a. The following section describes how these components can be designed in the context of additive manufacturing.

### 4.1 Observation Space

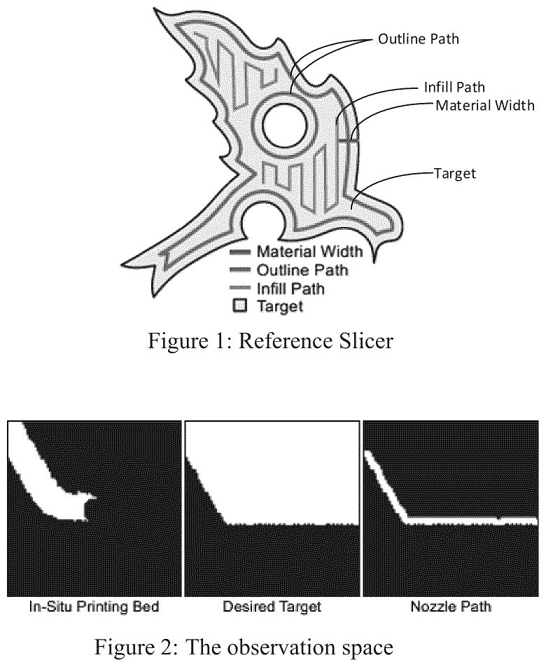

To define the observation space, the constraints of the physical hardware were closely followed. The observation space was modeled as a small in-situ view centered at the printing nozzle location. The view has a size of 84×84 pixels, which translates to roughly 2.95×2.95 scene units (SU). The view contains either a heightmap (for infill printing) or material segmentation (for outline printing). Since the location directly under the nozzle is obscured for the physical hardware, we mask a small central position in the view equivalent to 0.42 SU or 1/7th of the in-situ view. Together with the local view, the printer was provided with a local image of the desired printing target and an image of the path the control policy will take in the environment. To further minimize the observation space, the in-situ view was rotated such that the printer moves along the positive X-axis in the image. These three inputs are stacked together into a 3-channel image, FIG. 2.

### 4.2 Action Space

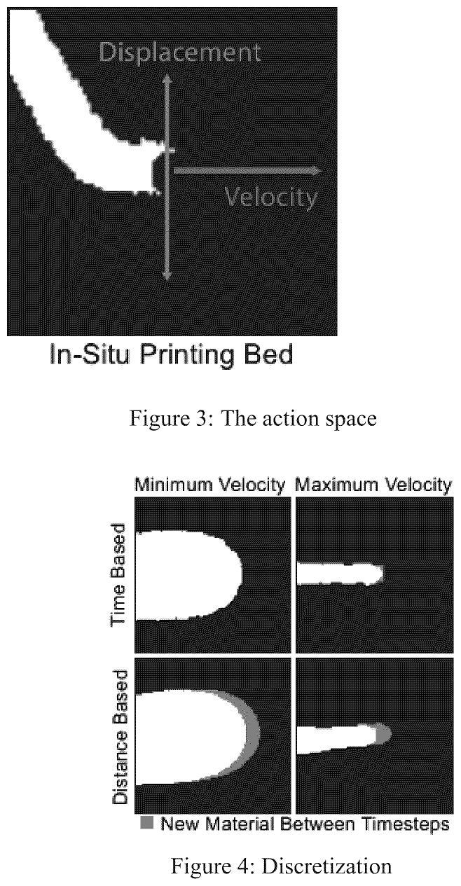

The selection of action space plays a critical role in adapting a controller to the real hardware. One possibility is to control and directly modify the acceleration of individual motors. However, such approach is not readily transferable between printing devices because, generally speaking, the controls are tied too tightly to the hardware selection and would exaggerate the sim-to-real gap. Moreover, directly affecting the acceleration motors would mean that the control policy needs to learn how to trace print inputs. Instead, a strategy is proposed that leverages the body of work on designing state-of-the-art controllers. Similar to the state-of-the-art, this control policy follows a path generated by a slicer. However, the control policy enables dynamic modification of the path. At each state, the printer can modify two actions: (1) the velocity at which the printing head is moving and (2) displacement of the printing head in a direction perpendicular to the motion, FIG. 3. Such a formulation allows for decoupling the acceleration profile from the control scheme and applying the same policy in both simulation and physical hardware by scaling the input units appropriately. In this simulation, velocity was limited to the range of [0.2, 2] SU/s and the displacement was limited to 0.2666 SU.

### 4.3 Transition Function

The transition function takes a state-action pair and outputs a new state of the environment. In the simulation setting, this means that the fabrication process needs to be numerically modeled, which is a notoriously difficult problem. Here, the system leverages the assumption that the observation space is so localized that it can identify the deposited materials only qualitatively. Therefore, the system can trade physical realism for visual fidelity and efficiency. This description fits the Position-Based-Dynamics (PBD) (Macklin & Müller, 2013) framework, which is a geometrical approximation to the equations of motion. For numerical details on how to approximate printing materials in the PBD framework, see Appendix C, which is incorporated herein physically and by reference.

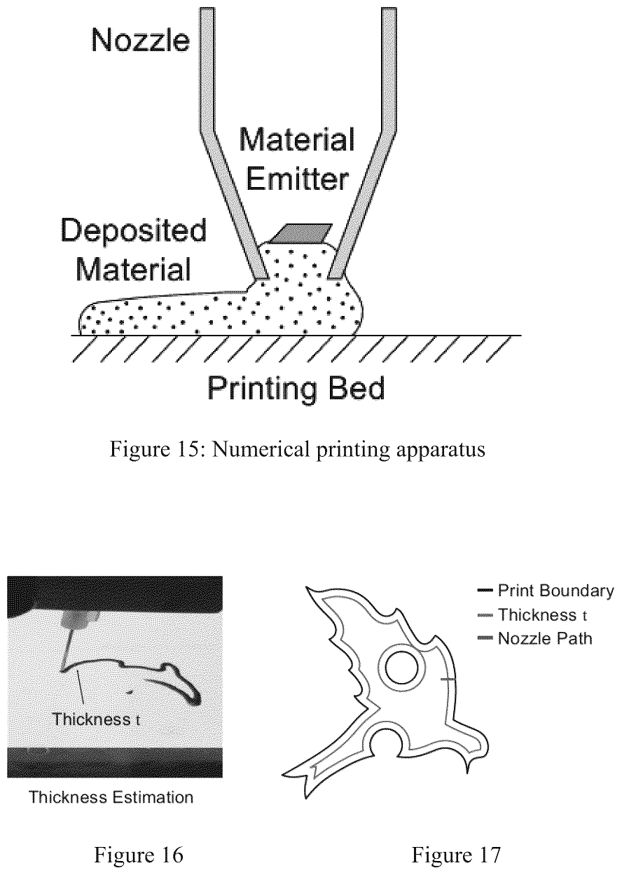

FIG. 15 depicts replication of the printing apparatus in the simulation. The nozzle is modeled as a collision object with hard contact constraint on the fluid particles. Since modeling a pressurized reservoir is computationally costly, as it requires modeling a large number of particles in constant contact, the deposition process was approximated at the peak of the nozzle. More specifically, the deposition was modeled as a particle emitter. To set the volume and velocity of the particles, a flow setting was used. The higher the flow, the more particles with higher initial velocities are generated. This qualitatively approximates the deposition process with a pressurized reservoir. The particle emitter is placed slightly inside the nozzle, which allows for realistic material buildup and a delayed stop similarly to extrusion processes. Finally, the printer was considered to have only a finite acceleration per time-step. To accelerate to target velocity, a linear acceleration scheme was employed.

Another important choice for the numerical model is the used discretization. There are have two options: (1) time-based and (2) distance-based. Time-based discretization was originally experimented. However, it was found that time discretization is not suitable for printer modeling. As the velocity in simulation approaches zero, the difference in deposited material becomes progressively smaller until the gradient information completely vanishes, FIG. 4 left. Moreover, a time-based discretization allows the policy to directly affect the number of evaluations of the environment. As a result, it can avoid being punished for bad material deposition by quickly rushing the environment to finish. Considering these factors, distance-based discretization was chosen, FIG. 4 right. At each interaction point, the policy specifies a desired velocity, and the environment travels a predefined distance (0.2666 SU) at the desired speed. This helps to regularize the reward function and enable learning of varying control policies.

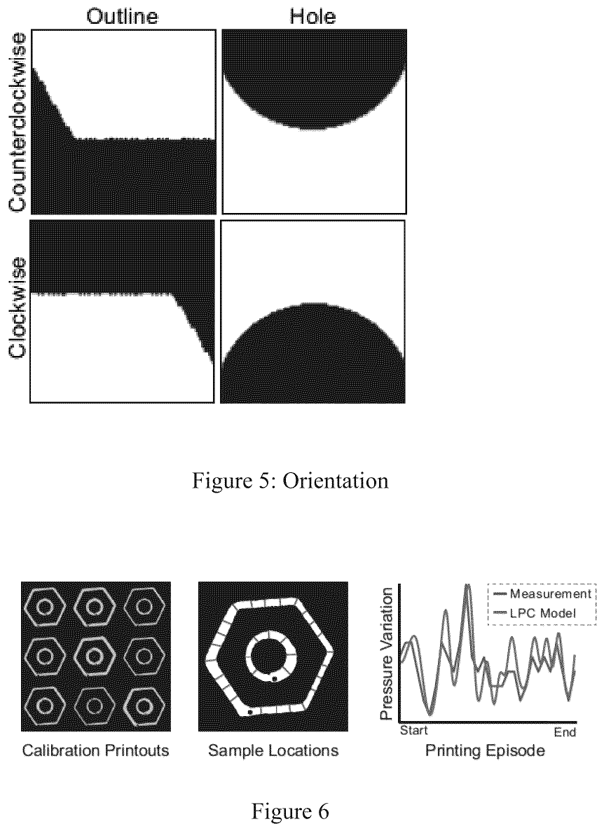

An interesting design element is the orientation of the control polygons created by gcode. When the outline is defined as points given counter-clockwise, then, due to the applied rotation, each view is split roughly into two half-spaces, FIG. 5, with the bottom one corresponding to outside i.e., generally being black, and the upper one corresponding to inside, i.e., generally being mostly white. However, the situation changes when outlining a hole. When printing a hole, the two half-spaces swap location. This disambiguity can be removed by changing the orientation of the polylines defining holes in the model. By orienting them in a clockwise manner, the two half-spaces will be effectively swapped to the same orientation as when printing the outer part. As a result, better usage of trajectories and a more robust control scheme that does not need to be separately trained for the outer and inner parts of each print is achieved.

To design a realistic printing environment, the model needs to capture the deposition imprecision. The source of this imprecision is the complex non-linear coupling between the dynamic material properties and the deposition parameters. Analytical modeling of this coupling is challenging, as it requires deep understanding of the complex coupled interactions. Instead, a data-driven model was adopted. It was observed that the final effect of the deposition error is a varying width of the deposited material.

To recover such a model for our apparatus, start by printing a reference slice over multiple iterations and measure the width variation at specified locations (e.g., cross-sections). This yields observations of how the material width evolves over time. To formulate a predictive generative model, a tool from speech processing called Linear Predictive Coding (LPC) (Marple, 1980) was employed. The model assumes that a signal is generated by a buzz filtered by an auto-correlation filter. This assumption was used to recover filter coefficients that transform white Gaussian noise into realistic pressure samples.

For one example, with reference to FIG. 6, nine printouts were performed (FIG. 6 left) and at each iteration the width of the deposited material at specified locations was measured (FIG. 6 middle). This yields observations of how the material width evolves over time (FIG. 6 left). The measured data was then fit with an LPC model to recover filter coefficients that transform white Gaussian noise into realistic pressure samples (FIG. 6 right). For numerical details, please see Appendix D, which is incorporated herein physically and by reference. It should be noted that since the model is generative, it does not exactly match the data; any observed resemblance is a testament to the quality of the predictor.

### 4.4 Reward Function

Viscous materials take significant time to settle after deposition. Therefore, to assess deposition errors, it is needed to observe the deposition over long horizons. However, the localized nature of the in-situ view makes such observations impossible on the physical hardware. As a result, learning long-horizon planning has infeasible sample complexity. To tackle this issue, the fact that we utilize a numerical approximation of the deposition process with access to privileged information was leveraged. At each simulation step, the model simulates the entire printing bed. This allows formulation of the reward function as a global print quality metric. More specifically, the metric is composed of two terms: (1) a reward term for depositing material inside the desired slice and (2) a punishment term for depositing material outside of the slice. To keep the values consistent across slices of varying size, the values were normalized by the length of the outline or the infill area, respectively. To accelerate the training further, dense rewards were provided as the difference between the metrics evaluated at two subsequent timesteps. For details on how to compute the reward function, see Appendix E, which is incorporated herein physically and by reference.

### 5 RESULTS

This section provides results collected in both virtual and real environments. For details about the training procedure, please see Appendix F, which is incorporated herein physically and by reference. It is first shown that an adaptive policy can outperform state-of-the-art approaches in environments with constant deposition. Next, the in-process monitoring and the ability of our policy to adapt to dynamic environments are showcased. This section concludes by demonstrating that the learned controllers transfer to physical environments with minimal sim-to-real gap.

5.1 Comparison with Reference Control Policy

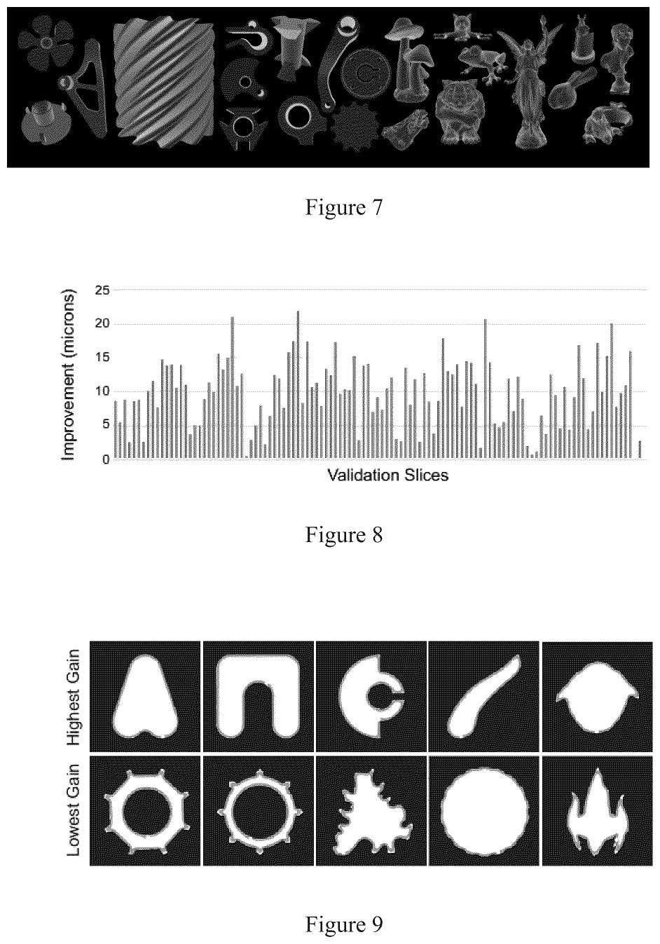

The optimized control scheme was evaluated on a selection of freeform models and CAD files sampled from Thingy 10k (Zhou & Jacobson, 2016) and ABC (Koch et al., 2019) datasets, FIG. 7. In total, there were 134 before unseen slices corresponding to before unseen geometries. Findings are reported in FIG. 8, which shows evaluation of the performance of the control policy visualized as an improvement over the reference. For each input slice, the difference between reward achieved by the control policy and the reference is reported. Therefore, a reward higher than zero indicates that the control policy outperformed the state-of-the-art. As shown in FIG. 8, the policy achieved better performance in each slice.

Next, the shapes where our control policy achieves the highest and the lowest gain respectively were investigated. From FIG. 9, which shows exemplar printouts from the evaluation dataset, it can be observed that the policy is performing the best on relatively smooth meshes (FIG. 9 top). The reason for this is that the policy is capable of adjusting the printing parameters based on the curvature, which allows it to adapt and more closely follow the boundaries of smooth objects. Conversely, the policy achieves the weakest performance on objects with very sharp features (FIG. 9 bottom). In these sharp regions, the thickness of the deposited material is too large for the desired feature scale. As a result, it is not possible to improve the material coverage without causing over-deposition.

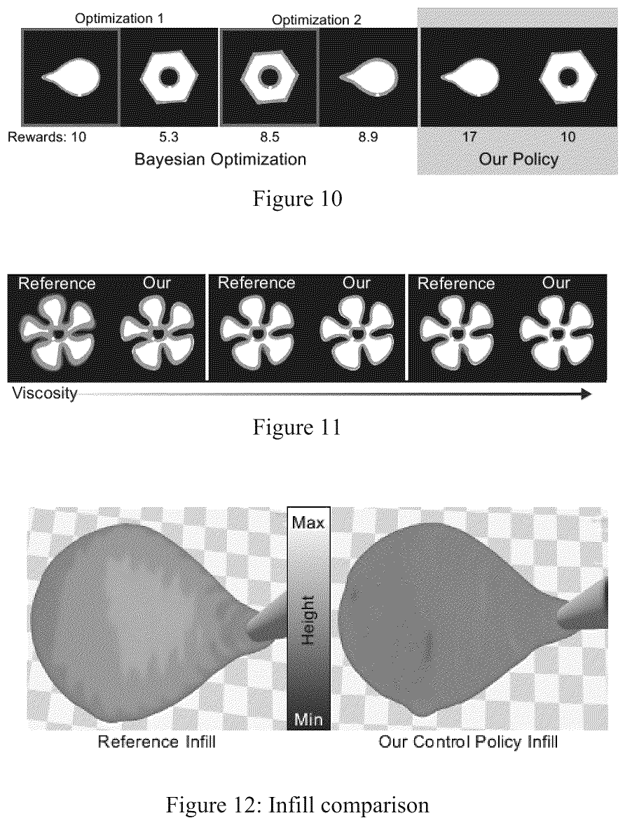

Finally, the control policy is compared with fine-tuned state-of-the-art. The reference control policy uses the same parameters for each slice. It is possible that different process parameters are optimal for different slices. To this end, two slices were chosen, a freeform slice of a bird and a CAD slice of a bolt and optimized their process parameters using Bayesian optimization. FIG. 10 shows printouts realized using control policies recovered with Bayesian optimization (left and middle, blue square marks the optimized slice) compared to the trained policy (right). For numerical details, see Appendix G, which is incorporated herein physically and by reference. It can be observed that the two control schemes required drastically different velocities (1.46 SU/s vs. 0.89 SU/s) to maximize performance. Moreover, it can be seen that the policies are not interchangeable. When swapping the control policies, a loss in performance can be observed. This loss is caused by each policy exploiting the local properties of the slice used for training. Lastly, the individually optimized policies are compared with our policy. Our policy improves upon both reference solutions while maintaining generalizability. This is possible because our control policy relies on live feedback that allows for adjusting the printing parameters on-the-fly.

### 5.2 Ablation Study on Observation Space

Our control policy relies on a live view of the deposition system to select the control parameters. However, the in-situ view is a technologically challenging addition to the printer hardware that requires a carefully calibrated imagining setup. With this ablation study, we verify how important the individual observations are to the final print quality. Three cases were considered: (1) no printing bed view, (2) no target view, and (3) no future path view. The performance of each case on the evaluation dataset is reported in the supplementary material below. The results were analyzed from the pre-test (full observation space M=9.74, SD=4.92) and the post-tests (no canvas M=8.75, SD=5.70, no target M=7.16, SD=5.45, no path M=8.42, SD=4.79) printing task using paired t-tests with Holm-Bonferroni correction. The analysis indicates that the availability of all three inputs: the printing bed, the target, and the path, resulted in an improvement in final printouts (P values<0.01 for all three cases).

### 5.3 Ablation Study on Viscosity

To verify that our policy can adapt to printing artifacts, three models of varying viscosity were trained in the noisy environments. FIG. 11 shows a comparison of state-of-the-art slicers with our policy in environments with varying viscosity. It can be observed that without an adaptive control scheme, the pressure changes are sufficiently strong to cause local over or under-deposition of material. Our trained policy improves upon this behavior and dynamically adjusts the offset and velocity to counterbalance the changes in deposition. It can be seen that our policy is especially good at handling smooth width changes and quickly recovers from a spike in printing width.

### 5.4 Infill Printing

The infill policy was also evaluated in a noisy environment. As shown in FIG. 12, it can be observed that the deposition noise leads to an accumulation of material. The accumulation eventually results in a bulge of material in the center of the print (e.g., the material distorts the top surface as shown by the greyscale changes in FIG. 12 in the reference infill), which would complicate the deposition of subsequent layers because the material would tend to slide off. In contrast, our policy dynamically adjusts the printing path to generate a print with significantly better surface smoothness. As can be observed, the surface generated by our policy is almost smooth and would be much more suitable for deposition of subsequent layers.

### 6 CONCLUSION

We present what is believed to be the first closed-loop controller for additive manufacturing guided by an in-situ view, which is also applicable, as discussed herein, to other manufacturing processes using different types of feedback. To learn an effective control policy, we design a custom numerical model of the deposition process where we tackle several challenges. To obtain an efficient approximation of the deposition process, we leverage the limited perception of a printing apparatus and model the deposition only qualitatively. To include non-linear coupling between process parameters and printed materials, we utilize a data-driven predictive model for the deposition width. Finally, to enable long-horizon learning with viscous materials, we use the privileged information generated by our numerical model for reward computation. We demonstrate that our model can be used to train control policies that outperform state-of-the-art, adapt to materials of varying viscosity, and transfer to physical apparatus with minimal sim-to-real gap. To showcase our controllers, we fabricate several printouts. We believe that our numerical model can guide future development of closed-loop policies for additive manufacturing. Thanks to its minimal sim-to-real gap the model democratizes research on learning for additive manufacturing by limiting the need to build specialized hardware.

Appendix H includes some supplemental information including a copy of a draft publication providing additional details of various embodiments, the contents of which are incorporated herein physically and by reference.

Appendix I includes some supplemental information including a copy of an updated publication providing additional details of various embodiments, the contents of which are incorporated herein physically and by reference.

### REFERENCES

Ilge Akkaya, Marcin Andrychowicz, Maciek Chociej, Mateusz Litwin, Bob McGrew, Arthur Petron, Alex Paino, Matthias Plappert, Glenn Powell, Raphael Ribas, et al. Solving rubik's cube with a robot hand. arXiv preprint arXiv: 1910.07113, 2019.
Ivanna Baturynska, Oleksandr Semeniuta, and Kristian Martinsen. Optimization of process parameters for powder bed fusion additive manufacturing by combination of machine learning and finite element method: A conceptual framework. Procedia Cirp, 67:227-232, 2018.
Jan Bender, Matthias Müller, Miguel A Otaduy, Matthias Teschner, and Miles Macklin. A survey on position-based simulation methods in computer graphics. In Computer graphics forum, volume 33, pp. 228-251. Wiley Online Library, 2014.
John Parker Burg. Maximum Entropy Spectral Analysis. Stanford Exploration Project. Stanford University, 1975.
Alexander Clegg, Wenhao Yu, Jie Tan, C Karen Liu, and Greg Turk. Learning to dress: Synthesizing human dressing motion via deep reinforcement learning. ACM Transactions on Graphics (TOG), 37 (6): 1-10, 2018.
Erwin Coumans and Yunfei Bai. Pybullet, a python module for physics simulation for games, robotics and machine learning. 2016.
Filipe de Avila Belbute-Peres, Kevin Smith, Kelsey Allen, Josh Tenenbaum, and J Zico Kolter. End-to-end differentiable physics for learning and control. Advances in neural information processing systems, 31:7178-7189, 2018.
Sarah Elliott and Maya Cakmak. Robotic cleaning through dirt rearrangement planning with learned transition models. In 2018 IEEE International Conference on Robotics and Automation (ICRA), pp. 1623-1630. IEEE, 2018.
Timothy Erps, Michael Foshey, Mina Konaković Luković, Wan Shou, Hanns Hagen Goetzke, Herve Dietsch, Klaus Stoll, Bernhard von Vacano, and Wojciech Matusik. Accelerated discovery of 3d printing materials using data-driven multi-objective optimization, arXiv preprint arXiv: 2106.15697, 2021.
Wei Gao, Yunbo Zhang, Devarajan Ramanujan, Karthik Ramani, Yong Chen, Christopher B Williams, Charlie C L Wang, Yung C Shin, Song Zhang, and Pablo D Zavattieri. The status, challenges, and future of additive manufacturing in engineering. Computer-Aided Design, 69:65-89, 2015.
Carlos E Garcia, David M Prett, and Manfred Morari. Model predictive control: Theory and practice-a survey. Automatica, 25 (3): 335-348, 1989.
Shixiang Gu, Timothy Lillicrap, Ilya Sutskever, and Sergey Levine. Continuous deep q-learning with model-based acceleration. In International conference on machine learning, pp. 2829-2838. PMLR, 2016.
Angus Johnson. Clipper-an open source freeware library for clipping and offsetting lines and polygons. http://www.angusj.com/delphi/clipper.php, 2015.
Branden Kappes, Senthamilaruvi Moorthy, Dana Drake, Henry Geerlings, and Aaron Stebner. Machine learning to optimize additive manufacturing parameters for laser powder bed fusion of inconel 718. In Proceedings of the 9th International Symposium on Superalloy 718 & Derivatives: Energy, Aerospace, and Industrial Applications, pp. 595-610. Springer, 2018.
Sebastian Koch, Albert Matveev, Zhongshi Jiang, Francis Williams, Alexey Artemov, Evgeny Burnaev, Marc Alexa, Denis Zorin, and Daniele Panozzo. Abc: A big cad model dataset for geometric deep learning. In The IEEE Conference on Computer Vision and Pattern Recognition (CVPR), June 2019.
Jeongseok Lee, Michael X Grey, Sehoon Ha, Tobias Kunz, Sumit Jain, Yuting Ye, Siddhartha S Srinivasa, Mike Stilman, and C Karen Liu. Dart: Dynamic animation and robotics toolkit. Journal of Open Source Software, 3 (22): 500, 2018.
Seunghwan Lee, Moonseok Park, Kyoungmin Lee, and Jehee Lee. Scalable muscle-actuated human simulation and control. ACM Transactions On Graphics (TOG), 38 (4): 1-13, 2019.
Yunzhu Li, Jiajun Wu, Russ Tedrake, Joshua B. Tenenbaum, and Antonio Torralba. Learning particle dynamics for manipulating rigid bodies, deformable objects, and fluids. In International Conference on Learning Representations, 2019a.
Yunzhu Li, Jiajun Wu, Jun-Yan Zhu, Joshua B Tenenbaum, Antonio Torralba, and Russ Tedrake. Propagation networks for model-based control under partial observation. In 2019 International Conference on Robotics and Automation (ICRA), pp. 1205-1211. IEEE, 2019b.
Chenang Liu, David Roberson, and Zhenyu Kong. Textural analysis-based online closed-loop quality control for additive manufacturing processes. In IIE Annual Conference. Proceedings, pp. 1127-1132. Institute of Industrial and Systems Engineers (IISE), 2017.
Libin Liu and Jessica Hodgins. Learning basketball dribbling skills using trajectory optimization and deep reinforcement learning. ACM Transactions on Graphics (TOG), 37 (4): 1-14, 2018.
Pingchuan Ma, Yunsheng Tian, Zherong Pan, Bo Ren, and Dinesh Manocha. Fluid directed rigid body control using deep reinforcement learning. ACM Transactions on Graphics (TOG), 37 (4): 1-11, 2018.
Miles Macklin and Matthias Müller. Position based fluids. ACM Transactions on Graphics (TOG), 32 (4): 1-12, 2013.
Larry Marple. A new autoregressive spectrum analysis algorithm. IEEE Transactions on Acoustics, Speech, and Signal Processing, 28 (4): 441-454, 1980. doi: 10.1109/TASSP.1980.1163429.
Volodymyr Mnih, Koray Kavukcuoglu, David Silver, Andrei A Rusu, Joel Veness, Marc G Belle-mare, Alex Graves, Martin Riedmiller, Andreas K Fidjeland, Georg Ostrovski, et al. Human-level control through deep reinforcement learning. nature, 518 (7540): 529-533, 2015.
Mojtaba Mozaffar, Arindam Paul, Reda Al-Bahrani, Sarah Wolff, Alok Choudhary, Ankit Agrawal, Kornel Ehmann, and Jian Cao. Data-driven prediction of the high-dimensional thermal history in directed energy deposition processes via recurrent neural networks. Manufacturing letters, 18:35-39, 2018.
Matthias Müller, David Charypar, and Markus H Gross. Particle-based fluid simulation for interactive applications. In Symposium on Computer animation, pp. 154-159, 2003.
Anusha Nagabandi, Gregory Kahn, Ronald S Fearing, and Sergey Levine. Neural network dynamics for model-based deep reinforcement learning with model-free fine-tuning. In 2018 IEEE International Conference on Robotics and Automation (ICRA), pp. 7559-7566. IEEE, 2018.
Junhyuk Oh, Satinder Singh, and Honglak Lee. Value prediction network. In NIPS, 2017.
Xue Bin Peng, Pieter Abbeel, Sergey Levine, and Michiel van de Panne. Deepmimic: Example-guided deep reinforcement learning of physics-based character skills. ACM Transactions on Graphics (TOG), 37 (4): 1-14, 2018.
Aravind Rajeswaran, Vikash Kumar, Abhishek Gupta, Giulia Vezzani, John Schulman, Emanuel Todorov, and Sergey Levine. Learning complex dexterous manipulation with deep reinforcement learning and demonstrations. arXiv preprint arXiv: 1709.10087, 2017.
Connor Schenck and Dieter Fox. Spnets: Differentiable fluid dynamics for deep neural networks. In Conference on Robot Learning, pp. 317-335. PMLR, 2018.
John Schulman, Filip Wolski, Prafulla Dhariwal, Alec Radford, and Oleg Klimov. Proximal policy optimization algorithms. arXiv preprint arXiv: 1707.06347, 2017.
David Silver, Hado Hasselt, Matteo Hessel, Tom Schaul, Arthur Guez, Tim Harley, Gabriel Dulac-Arnold, David Reichert, Neil Rabinowitz, Andre Barreto, et al. The predictron: End-to-end learning and planning. In International Conference on Machine Learning, pp. 3191-3199. PMLR, 2017.
Pitchaya Sitthi-Amorn, Javier E Ramos, Yuwang Wangy, Joyce Kwan, Justin Lan, Wenshou Wang, and Wojciech Matusik. Multifab: a machine vision assisted platform for multi-material 3d printing. Acm Transactions on Graphics (Tog), 34 (4): 1-11, 2015.
Aravind Srinivas, Allan Jabri, Pieter Abbeel, Sergey Levine, and Chelsea Finn. Universal plan-ning networks: Learning generalizable representations for visuomotor control. In International Conference on Machine Learning, pp. 4732-4741. PMLR, 2018.
Chao Tang, Jie Lun Tan, and Chee How Wong. A numerical investigation on the physical mechanisms of single track defects in selective laser melting. International Journal of Heat and Mass Transfer, 126:957-968, 2018.
Emanuel Todorov, Tom Erez, and Yuval Tassa. Mujoco: A physics engine for model-based control. In 2012 IEEE/RSJ International Conference on Intelligent Robots and Systems, pp. 5026-5033. IEEE, 2012. Marc A Toussaint, Kelsey Rebecca Allen, Kevin A Smith, and Joshua B Tenenbaum. Differentiable physics and stable modes for tool-use and manipulation planning. 2018.
Chengcheng Wang, Xipeng Tan, Erjia Liu, and Shu Beng Tor. Process parameter optimization and mechanical properties for additively manufactured stainless steel 3161 parts by selective electron beam melting. Materials & Design, 147:157-166, 2018.
Chengcheng Wang, XP Tan, SB Tor, and CS Lim. Machine learning in additive manufacturing: State-of-the-art and perspectives. Additive Manufacturing, pp. 101538, 2020.
Yilin Wu, Wilson Yan, Thanard Kurutach, Lerrel Pinto, and Pieter Abbeel. Learning to manipulate deformable objects without demonstrations. arXiv preprint arXiv: 1910.13439, 2019.
Wentao Yan, Ya Qian, Wenjun Ge, Stephen Lin, Wing Kam Liu, Feng Lin, and Gregory J Wagner. Meso-scale modeling of multiple-layer fabrication process in selective electron beam melting: inter-layer/track voids formation. Materials & Design, 141:210-219, 2018.
Bing Yao, Farhad Imani, and Hui Yang. Markov decision process for image-guided additive manufacturing. IEEE Robotics and Automation Letters, 3 (4): 2792-2798, 2018.
Ri Yu, Hwangpil Park, and Jehee Lee. Figure skating simulation from video. In Computer graphics forum, volume 38, pp. 225-234. Wiley Online Library, 2019.
Yunbo Zhang, Wenhao Yu, C Karen Liu, Charlie Kemp, and Greg Turk. Learning to manipulate amorphous materials. ACM Transactions on Graphics (TOG), 39 (6): 1-11, 2020.
Qingnan Zhou and Alec Jacobson. Thingi10k: A dataset of 10,000 3d-printing models. arXiv preprint arXiv: 1605.04797, 2016.

### APPENDICES

The following appendices are incorporated herein physically and by reference.

### APPENDIX A—HARDWARE SETUP

### A.1 Calibration

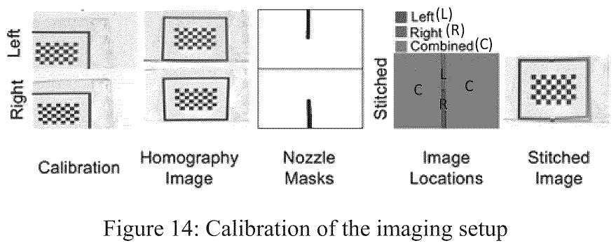

To enable realtime control of the printing process, we implemented an in-situ view of the material deposition. Ideally, we would capture a top-down view of the deposited material. Unfortunately, this is not possible, since the material is obstructed by the dispensing nozzle. As a result, the camera has to observe the printing bed from an angle. Since the nozzle would obstruct the view of any single camera, we opted to use two cameras. More specifically, we placed two CMOS cameras (Basler AG, Ahrensburg, Germany) at 45 degrees on each side of the dispensing nozzle, as shown in FIG. 13. We calibrate the camera by collecting a set of images and estimating its intrinsic parameters (FIG. 14 Calibration). To obtain a single top-down view, we capture a calibration target aligned with the image frames of both cameras (FIG. 14 homography). By calculating the homography between the captured targets and an ideal top-down view, we can stitch the images into a single view from a virtual over-the-top camera. Finally, we mask the location of each nozzle in the image, e.g., by thresholding a photo of the nozzle (FIG. 14 nozzle masks) and obtain the final in-situ view (FIG. 14 Stitched Image) from four component regions: (1) view only in left camera, (2) view only in right camera, (3) view in both cameras, (4) view in no camera (FIG. 14 Image Locations).

The recovered in-situ view is scaled to attain the same universal scene unit size as our control policies are trained in. Since we seek to model the deposition only qualitatively, it is sufficient to rescale the in-situ view to match the scale of the virtual environments. We identify this scaling factor separately for each material. To calibrate a single material, we start by depositing a straight line at maximum velocity. The scaling factor is then the ratio required to match the observed thickness of the line with simulation.

The last assumption of our control policy is that the deposition needle is centered with respect to the in-situ view. To ensure that this assumption holds with the physical hardware, we calibrate the location of the dispensing needle within the field of view of each camera and with respect to the build platform. First, a dial indicator is used to measure the height of the nozzle in z and the fine adjustment stage FIG. 13 is adjusted until the nozzle is 254 microns above the print platform. Next, using a calibration target located on the build platform and the fine adjustment stage, the nozzle is centered in the field of view of each camera. This calibration procedure is done each time the nozzle is replaced during the start of each printing session.

### APPENDIX B—REFERENCE CONTROL POLICY

To calibrate the reference control, we follow the same procedure in simulation and physical hardware. We start by depositing a line (e.g., a straight line) at a constant velocity. Next, we measure the width of the deposited line at various locations to estimate the mean width. We use the width to generate the offset for outline printing and spacing of the infill pattern. FIG. 16 demonstrates thickness estimation in accordance with one embodiment. FIG. 17 shows print boundary, thickness, and nozzle path for the thickness estimation shown in FIG. 16. As shown in FIGS. 16 and 17, the reference printing policy starts by estimating the thickness t of the deposited material. A control sequence for the nozzle is estimated by offsetting the desired shape by half the size of material thickness.

### APPENDIX C—NUMERICAL SIMULATION SETUP

To model the interaction of the deposited material with the printing apparatus, we rely on Position-Based Dynamics (PBD). PBD approximates rigid, viscous, and fluid objects as collections of particles. To represent the fluid, we assume a set of N particles, where each particle is defined by its position p, velocity v, mass m, and a set of constraints C. In our setting, we consider two constraints: (1) collision with the nozzle and (2) incompressibility of the fluid material. We model the collision with the nozzle as a hard inequality constraint:

$${C}_{i} ( {p}_{i} ) = ( {p}_{i} - {q}_{c} ) \cdot {n}_{c} , \qquad ( 1 )$$

where q_{c} is the contact point of a particle with the nozzle geometry along the direction of the particle's motion v and n_{c} is the normal at the contact location. To ensure that our fluids remain incompressible, we follow (Macklin & Müller, 2013) and formulate a density constraint for each particle:

$${C}_{i} ( {p}_{1} , … , {p}_{n} ) = \frac{{ρ}_{i}}{{ρ}_{0}} - 1 , \qquad ( 2 )$$

$${ρ}_{i} = {\sum }_{j} {m}_{j} W ( {p}_{i} - {p}_{j} , h ) , \qquad ( 3 )$$

where ρ₀ is the rest density and ρᵢ is given by a Smoothed Particle Hydrodynamics estimator (Müller et al., 2003) in which W is the smoothing kernel defined by the smoothing scale h.

We further tune the simulation parameters to achieve a wide range of viscosity properties. More specifically, we couple the effects of viscosity, adhesion, and energy dissipation into a single setting. By coupling these parameters, we obtain materials with optically different viscosity properties. Moreover, we noticed that the number of solving steps has a significant effect on viscosity and surface tension of the simulated fluids. Therefore, we also tweak the number of substeps from 2 for liquid-like materials to 5 for highly-viscous materials.

### Appendix D—Approximating Machine Noise with Linear Predictive Coding

To formulate a predictive generative model, we employ a tool from speech processing called Linear Predictive Coding (LPC) (Marple, 1980). We can predict the next sample of a signal as a weighted sum of M past output samples and a noise term:

$${x}_{n} = - {\sum }_{m = 1}^{M} {a}_{M , m} {x}_{n - m} + {ϵ}_{n} , \qquad ( 4 )$$

where x are the signal samples, ∈ is the noise term, and a_{M,m} are the parameters of M-th order auto-correlation filter. To find these coefficients, Burg (1975) propose to minimize the following energies:

$${ϵ}_{M} = {\sum }_{k = 1}^{N - m} {\vert {f}_{M , k} \vert}^{2} + {\sum }_{k = 1}^{N - m} {\vert {b}_{M , k} \vert}^{2} , \qquad ( 5 )$$

$${f}_{M , k} = {\sum }_{i = 0}^{M} {a}_{M , i} {x}_{k + M - i} , \qquad ( 6 )$$

$${b}_{M , k} = {\sum }_{i = 0}^{M} {a}_{M , i}^{*} {x}_{k + i} , \qquad ( 7 )$$

where * denotes the complex conjugate. After finding the filter coefficients with Equation 5, we can synthesize new width variations with similar frequency composition to the physical hardware by filtering a buzz modeled as a white Gaussian noise. Since we sampled the width variation at discrete intervals, we further find a smooth interpolating curve that corresponds the model to the observed pressure variation (i.e., we interpolate the discrete measurements to get a continuous function that represent the pressure variation along the entire dispensed line). We use the proposed model to drive the flow setting of our simulator. This directly influences the width of the deposited material similarly to the imperfections in the deposition.

### APPENDIX E—REWARD FUNCTION CALCULATION

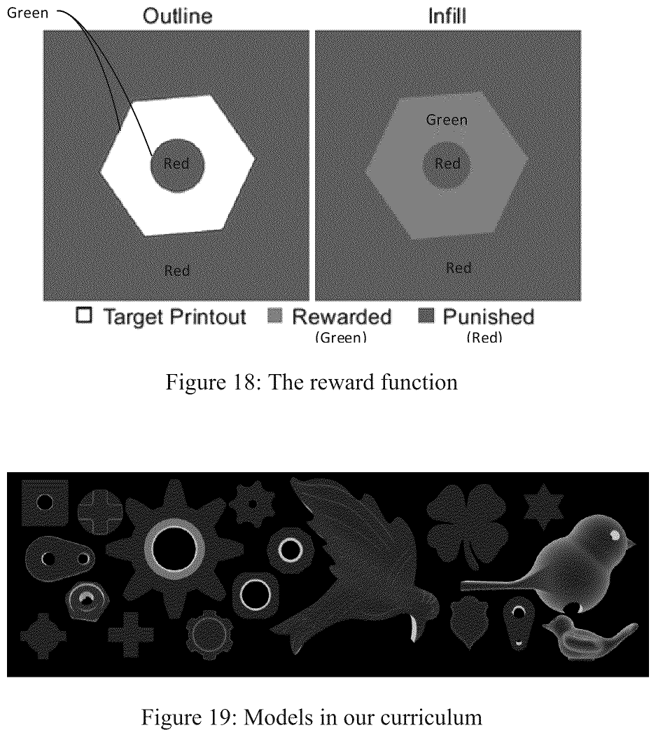

As depicted in FIG. 18, we consider two reward functions in our setting, one for outline printing (FIG. 18—left) and one for infill printing (FIG. 18—right). Each reward function evaluates the printout quality as a whole. To accelerate the learning, we provide the algorithm with dense rewards as a delta between the reward in-between steps R=Rⁿ⁺¹−Rⁿ.

To print the outline (FIG. 18—left, green, we want to follow the boundary as closely as possible without overfilling. To this end, we compose our reward function of two terms. Given an image of the current printing bed C and the desired target T, we define the reward as ΣCT. While such a formulation rewards the control policy for depositing material inside the printing volume, it does not encourage a tight outline fill. Indeed, a potential strategy with such a reward would be to offset the printing nozzle as much inside as possible and then move safely within the object bounds. To address this issue, we propose to include a weight map W that is computed as a thresholded distance transform of the target T. The final reward function is then: R=ΣCTW. Using such a formulation, we put the highest weight on depositing directly on the outline boundary. The increased reward on depositing directly on the outline boundary helps to prevent a strategy of filling up the shape interior. To ensure that the printer deposits material inside the desired locations, we include an additional punishment term P=ΣC (1−T). Finally, both reward and punishment are normalized by the length of the outline of our target.

For infill printing, we compute the reward from the heightfield of the deposited material. We start by estimating how much of the slice was covered. To this end, we use a thresholded version of the canvas and compute the coverage as R=>ΣCT. Similarly, we estimate the amount of over-deposited material as P=ΣC(1−T). To keep these values consistent across different slices, we normalize them by the total area of the print. Finally, to motivate deposition of flat surfaces suitable for 3D printing, we add another penalty term as the standard deviation of the canvas heightfield.

### APPENDIX F—TRAINING PROCEDURE

To train our control policy, we start with g-code generated by state-of-the-art slicer. As inputs to the slicer, we consider a set of 3D models collected from the Thingy 10k dataset. To train a controller, the input models need to be carefully selected. On the one hand, if we pick an object with too low frequency features with respect to the printing nozzle size, then any printing errors due to control policy will have negligible influence on the final result. On the other hand, if we pick a model with too high frequency features with respect to the printing nozzle, then the nozzle will be physically unable to reproduce these features. As a result, we opted for a manual selection of 18 models that span a wide variety of features, FIG. 19. Each model is scaled to fit into a printing volume of 18×18 SU and sliced at random locations.

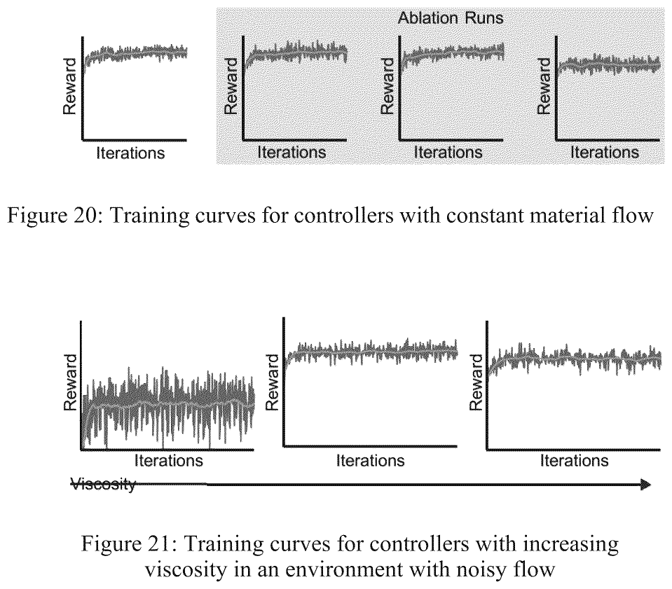

We adopt the model architecture of Mnih et al. (2015). The network input is 84×84 pixel image. The image is passed through three hidden layers. The convolution layers have the respective parameters: (32 filters, filter size 8, stride 4), (64 filters, filter size 4, stride 2), and (64 filters, filter size 3, stride 1). The final convolved image is linearized and passed through a fully-connected layer with 512 neurons that is connected to the output action. Each hidden layer uses nonlinear rectifier activation. We formulate our objective function as:

$${arg max}_{θ} {𝔼}_{t}^{C} [ \frac{\text{?} ( {a}_{t} \vert {s}_{t} )}{\text{?} ( {a}_{t} \vert {s}_{t} )} {\hat{A}}_{t} ] , \qquad ( 8 )$$

$$\text{?} \text{indicates text missing or illegible when filed}$$

where t is a timestep in the optimization, θ are the hyperparameters of a neural network encoding our policy π that generates an aₜ action at based on a set of observations sₜ, Âₜ is the estimator of the advantage function, and the expectation [symbol] ₜ^{C} is an average of a finite batch of samples generated by printing sliced models from our curriculum C. To maximize Equation 8, we use PPO algorithm (Schulman et al., 2017). Each trajectory consists of a randomly selected mesh slice that is fully printed out before proceeding to the next one. One epoch terminates when we collect 10000 observations. We run the algorithm for a total of 4 million observations, but convergence was achieved well before that (see FIG. 20, which shows training curves for controllers with constant material flow). For the training parameters, we set the entropy coefficient to 0.01 and anneal it towards 0. Similarly, we anneal the learning rate from 3e-4 towards zero. Lastly, we picked a discount factor of 0.99, which corresponds to one action having a half time of 70 steps. This is equivalent to roughly 18.6 SU of distance traveled. In our training set, this corresponds to 29-80 percent of the total episode length.

We also experimented with training controllers for materials with varying viscosity. FIG. 21 shows training curves for controllers with increasing viscosity in an environment with noisy flow. In general, we have observed that the change in viscosity did not significantly affect the learning convergence. However, we have observed a drop in performance when training control policies for deposition of liquid materials. The liquid material requires longer time horizons to stabilize and has a wider deposition area, making precise tracing of fine features challenging.

### APPENDIX G—BAYESIAN OPTIMIZATION FOR STATE-OF-THE-ART CONTROL

While the state-of-the-art reference policy closely follows the printed boundaries, it is possible that there is a more suitable policy to maximize our objective function. To verify this, we use the environment described in Section 4 to search for a velocity and offset that maximizes the reward function. More specifically, we optimize a simplified objective of Equation 8 limited to a single shape:

$${arg max}_{v , d} 𝔼 [ {π}_{v , d} ( {a}_{t} \vert {s}_{t} ) ] , \qquad ( 9 )$$

where v and d are the optimized velocity and displacement of the printing policy π_{v,d}, and [symbol] reduces to the expected cumulative reward of executing our proposed environment with a single slice. Maximizing Equation 9 even for a single shape is a challenging task due to the high cost associated with evaluating the objective function. Because of this, we rely on Bayesian optimization to maximize the objective. We warm-start the optimization with 20 samples acquired through Latin sampling of our 2-dimensional action space. We run the optimization until convergence, which we define as not improving upon the found maxima for over 300 iterations.

### APPENDIX H—SUPPLEMENTAL INFORMATION

This Appendix provides some supplemental information including the contents of the draft publication entitled CLOSED-LOOP CONTROL OF ADDITIVE MANUFACTURING VIA REINFORCEMENT LEARNING providing additional details of various embodiments, which was incorporated physically and by reference in PCT Application No. PCT/US2022/045662 and in U.S. Provisional Patent Application No. 63/252,418, from which this patent application claims priority and which are incorporated herein by reference.

The present disclosure relates to the control of manufacturing processes by using a reinforcement learning agent to select process parameters that result in increasing the quality of manufacturing outcomes. The reinforcement learning controller enables a higher level of control that typical control methods cannot achieve.

Many manufacturing processes rely on selecting and controlling a set of essential process parameters to ensure that the quality of the outcome meets specifications. Traditionally, closed-loop controllers are employed to control the process parameters to ensure that the process stays in a window that produces acceptable results. However, in circumstances where the stochastic error is difficult to model, or deterministic error is difficult to remove, many controllers that are currently used have reduced performance, limiting the ability to control the manufacturing process adequately. This causes reduced efficiency in the manufacturing process and, in some cases, makes the process infeasible.

We propose a novel control system that utilizes a policy network for controlling the manufacturing process. To train the policy network, a learning environment is used that effectively models the relationship between the process parameters and result as well as a reward function that penalizes or rewards the policy depending on how well the policy performed. During training, the policy network selects a set of process parameters to test in the learning environment, and the learning environment then reports back the manufacturing outcome and reward based on those process parameters. The policy network updates during training to maximize the total reward from the environment. After training, the policy network can then be used directly as the controller for the manufacturing process.

This new controller is manufacturing process agnostic and can be used on many different types of manufacturing processes such as additive manufacturing, CNC machining, metal forming and joining and more. To be adapted to different processes, a new environment that adequately models the different manufacturing process as well as an altered reward function are needed. To adequately represent the manufacturing process, the training environment can be a physical or computational environment that models the effects the process parameters have on the outcome. Furthermore, stochastic effects on process parameters can also be included in the environment.

We formulate our reward function as a combination of local and global quality metrics. The local quality metrics ensure that the outcome of the manufacturing process is optimal by rewarding desirable performance metrics. We do this, for example, by rewarding consistent line thickness for additive manufacturing, high quality surface finishes for CNC machining, attaining welds with high penetration and minimal defects for welding, or other appropriate qualitative analysis for a given manufacturing process. The global metrics are designed to evaluate the quality of geometrical reproduction. We do this by estimating the amount of material deposited/removed from desirable and undesirable regions for additive or subtractive manufacturing. A weighted combination of these factors describes how close we are to matching a target outcome and how well the next layer can be processed.

Thus, embodiments can be applied to a wide range of manufacturing processes using any of a wide variety of feedback mechanisms. Manufacturing systems of various embodiments can be generalized as comprising a tool configured to interact with or produce a product, at least one sensor that provides sensor information on the quality of the operation of the tool relative to the product, and a controller configured to control operation of the tool based on a predetermined manufacturing process and further configured to dynamically adjust at least one parameter of the predetermined manufacturing process and hence to dynamically adjust operation of the tool based on qualitative performance information derived from the sensor information applied as feedback to a closed-loop control policy learned through machine reinforcement learning. Embodiments can be applied to a wide range of manufacturing processes, e.g., without limitation, additive manufacturing processes, subtractive manufacturing processes, automated welding processes, automated cutting processes (e.g., mechanical, laser, waterjet), etc. Also, embodiments can use any of a variety of qualitative feedback mechanisms, e.g., without limitation, camera, 3D laser scanner, coordinate measuring machine, etc. The reinforcement learning/training and process control described herein can be adapted for a particular manufacturing process/system, e.g., rather than depositing test samples and measuring parameters of the deposited materials as in 3D printing embodiments described above, the learning/training and process control might be based on test welds in an automated welding system or on test cuts in an automated cutting system, using transfer and reward functions that are appropriate for the particular manufacturing process. As is generally known, variance and stochastic error make many manufacturing processes difficult to control. With the described methodologies of adding variance to the training environment, many types of manufacturing processes can be controlled even though they have stochastic error.

### APPENDIX I—ADDITIONAL SUPPLEMENTAL INFORMATION

This Appendix provides some supplemental information including the contents of an updated publication entitled CLOSED-LOOP CONTROL OF DIRECT INK WRITING VIA REINFORCEMENT LEARNING along with it Supplementary Material providing additional details of various embodiments, which was incorporated physically and by reference in PCT Application No. PCT/US2022/045662 and in U.S. Provisional Patent Application No. 63/252,418, from which this patent application claims priority and which are incorporated herein by reference.

### MISCELLANEOUS in

It should be noted that headings are used above for convenience and are not to be construed as limiting the present invention in any way.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Various inventive concepts may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Although the above discussion discloses various exemplary embodiments of the invention, it should be apparent that those skilled in the art can make various modifications that will achieve some of the advantages of the invention without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. A manufacturing system comprising:
a tool configured to interact with or produce a product;
at least one sensor that provides sensor information on the quality of the operation of the tool relative to the product; and
a controller configured to control operation of the tool based on a predetermined manufacturing process and further configured to dynamically adjust at least one parameter of the predetermined manufacturing process to thereby dynamically adjust operation of the tool based on qualitative performance information derived from the sensor information applied as feedback to a closed-loop control policy learned through machine reinforcement learning.

2. A system according to claim 1, wherein the tool performs an additive manufacturing process.

3. A system according to claim 1, wherein the tool performs a subtractive manufacturing process.

4. A system according to claim 1, wherein the at least one sensor comprises:
at least one camera;
a 3D laser scanner; and/or
a coordinate measuring machine.

5. A system according to claim 1, wherein:
the tool comprises a 3D printer having a material dispenser;
the at least one sensor comprises at least one camera configured to provide images of a location around the deposition; and
the closed-loop control policy uses qualitative performance information derived from the images.

6. A system according to claim 5, wherein the qualitative performance information comprises both deposition and variance of deposition.

7. A system according to claim 5, wherein the at least one parameter comprises (1) the velocity at which the printing head is moving and/or (2) displacement of the printing head in a direction perpendicular to the motion.

8. A system according to claim 1, wherein the tool comprises a CNC machine.

9. A system according to claim 1, wherein the controller utilizes a policy network for controlling the manufacturing process, the policy network trained using a learning environment that models the relationship between the process parameters and result as well as a reward function that penalizes or rewards the policy depending on how well the policy performed.

10. A system according to claim 1, wherein the controller is manufacturing process agnostic such that the controller can be used on different types of manufacturing processes.

11. A method comprising:
learning a self-correcting closed-loop control policy through machine reinforcement learning for a manufacturing process that involves on-the-fly adjustment of process parameters to handle inconsistencies in the manufacturing process and material formulations; and
controlling operation of a tool configured to interact with or produce a product including dynamically adjusting at least one parameter of the manufacturing process to thereby dynamically adjust operation of the tool based on qualitative performance information derived from at least one sensor applied as feedback to the closed-loop control policy learned through machine reinforcement learning.

12. A method according to claim 11, wherein the tool performs an additive manufacturing process.

13. A method according to claim 11, wherein the tool performs a subtractive manufacturing process.

14. A method according to claim 11, wherein the at least one sensor comprises:
at least one camera;
a 3D laser scanner; and/or
a coordinate measuring machine.

15. A method according to claim 11, wherein:
the tool comprises a 3D printer having a material dispenser;
the at least one sensor comprises at least one camera configured to provide images of a location around the deposition; and
the closed-loop control policy uses qualitative performance information derived from the images.

16. A method according to claim 15, wherein the qualitative performance information comprises both deposition and variance of deposition.

17. A method according to claim 15, wherein the at least one parameter comprises (1) the velocity at which the printing head is moving and/or (2) displacement of the printing head in a direction perpendicular to the motion.

18. A method according to claim 11, wherein the tool comprises a CNC machine.

19. A method according to claim 11, wherein the controlling utilizes a policy network for controlling the manufacturing process, the policy network trained using a learning environment that models the relationship between the process parameters and result as well as a reward function that penalizes or rewards the policy depending on how well the policy performed.

20. A method according to claim 11, wherein the controlling is manufacturing process agnostic such that the controller can be used on different types of manufacturing processes.
